(19) United States
(12) Patent Application Publication
(10) Pub. No.: US 2016/0232602 A1
(43) Pub. Date: Aug. 11, 2016

(54) METHOD AND SYSTEM FOR TRADING VIRTUAL CARD FOR RENTAL AND LEASE CONTRACT

(71) Applicants: Dae Yong KO, Seoul (KR); Jung Soo KO, Seoul (KR)

(72) Inventors: Dae Yong KO, Seoul (KR); Jung Soo KO, Seoul (KR)

(21) Appl. No.: 14/376,453

(22) PCT Filed: Oct. 24, 2013
(86) PCT No.: PCT/KR2013/009490

§ 371 Date: Aug. 4, 2014

(30) Foreign Application Priority Data
Apr. 1, 2013 (KR) 10-2013-0034983

(51) Int. Cl. G06Q 30/06

(52) U.S. Cl. CPC G06Q 30/0645

(57) ABSTRACT

A virtual card trading (or circulating) market system and a trading method thereof is associated with a virtual card purchase reservation receiving and transmitting module and a personal credit information providing agreement receiving and transmitting module and circulates an automatically created virtual card in association with sales information of a seller and lease information of a lessor by trading the virtual card in a lease market as a means for information effect based on the Internet, in an information asymmetry situation of a sales object and a leasehold object of the seller.

### BACKGROUND OF THE INVENTION

1. Field of the Invention

The present invention relates to a system and method for trading a virtual card for a rental and lease contract, and more specifically, to a network-based system and method for trading a virtual card to achieve an information effect or a signal effect for information efficiency, in an information asymmetry rental or lease contract.

2. Background of the Related Art

A user may use an object, such as an object, goods, product, service, etc.(herein after, referred to as simply “object”), generally in a method of visiting a store and purchasing the object by paying the seller in cash, or borrowing money for purchasing the object from a financial company and paying the seller for the object, or directly or indirectly leasing the object from a lessor by directly or indirectly selecting the object or with the intervention of a seller in a lease market in which a lessee has an off-balance-sheet financing effect.

A target of lease which is one of methods of using an object by a lessee may be classified as a real estate or a personal object, which are properties in a civil law. A general method of leasing a real estate is directly or indirectly making a lease contract between a lessor, i.e., the owner of the object, and a lessee who desires to use the object taking into account a market price, and a general method of leasing a personal object is introducing a lessor to a lessee by the seller of the object, making a rental or lease contract and paying a brokerage (a commission) to the seller by the lessor, and a different law may be applied according to a corresponding object in some cases.

Generally, three types of groups exist to accomplish a lease contract. Here, it is assumed that all the persons who supply or sell an object including persons who construct and supply an object or provide a service are referred to as a seller (having an ownership or a right to use), persons who purchase (transfer of the ownership or the right to use) and possess the object supplied by the seller to run a lease business are referred to as a lessor (having an ownership or a right to use), and persons leasing a corresponding object from the lessor (transfer only the right to use) and using the object is referred to as a lessee (having a right to use). Meanwhile, even in a case where a seller is also a lessor, the terms of the seller and the lessor will be used separately.

It may be said that a conventional trade is close to a passive trading method for making a lease contract with a lessor according to the brokerage of the seller having plenty of information on sales properties, rather than a method in which a lessee aggressively searches for a lessor or actively negotiating a dealing price or conditions in order to lease a corresponding object, since information on sales properties asymmetrically exist in a lease market.

It is general that an equilibrium price of a transaction is determined according to the law of demand and supply in a general market, which may be regarded as a basis of economics. However, in the case of a lease market, since a lessor who is a supplier seldom has chances to directly meet a lessee who is a consumer and a seller directly contacts with the lessee at a show room in many cases, although the seller who is a supplier sells an object to the lessor who is a consumer, the seller dominates a deal between the seller and the lessor since the seller introduces the lessee, i.e., a consumer of the lessor, to the lessor. Accordingly, it is general that when the lessor makes a lease contract with the lessee, the lessor pays an agency cost requested by the seller in return for the time and cost needed to let the lessor obtain information on the lessee from the seller in an information asymmetry situation.

For this reason, the lessee cannot but make a lease contract in a structure in which it is difficult to confirm whether or not the lease price for an object used by the lessee is properly and reasonably calculated, and, furthermore, an abnormal return is unevenly generated due to an overreaction and a delayed reaction while new information affects a market price. Although it is natural in principle that the lessor calculates a lease price for the lessee, it is general in reality that the seller quotes a lease price instead while interviewing the lessee. Accordingly, it may be said that the seller has information asymmetry over the lessee in calculating a selling price and a lease price.

In calculating a lease price, a monthly rental fee (a lease fee) is calculated by adding an agency cost of the seller to the profit, taxes, utility fees and other expenses of the lessor using a price for supplying an object to the lessor by the seller as a base amount (an acquisition cost), and the monthly rental fee is finally calculated by applying a discount rate of cash flow reflecting the time value of money to the monthly rental fee. Therefore, although the lessee exhibits a bargaining ability so that the seller sells an object to the lessor at a discounted selling price (i.e, the base amount is lowered), since an information asymmetry situation continuously occurs in reality for the sales object due to an unstable state of the lease market, time and cost are required for the lessee to obtain information. That is, since the seller increases the agency cost received from the lessor instead of discounting the price of the sales object in order to make a profit of his or her own, the lease fee paid by the lessee includes even the increased agency cost of the seller, and thus an unfair deal is made from the viewpoint of the lessee.

### SUMMARY OF THE INVENTION

Therefore, the present invention has been made in view of the above problems, and it is an object of the present invention to provide a virtual card trading (or distributing) market system and a trading (or distributing) method thereof, which is connected to a virtual card purchase reservation receiving and transmitting module and a personal credit information providing agreement receiving and transmitting module, and distributes an automatically created virtual card in association with sales information of a seller and lease information of a lessor by trading the virtual card in a lease market as a means for information effect based on the Internet, in an information asymmetry situation of a sales object and a leasehold object of the seller.

The basic spirit of the present invention for accomplishing the above object is that if a seller repeatedly inputs and stores discounted sales information in a virtual card trading web page, a lessor repeatedly fetches the discounted sales information and processes and stores lease information, and the lease information stored as such is used to automatically create a virtual card, in which the lease information is inserted, using a previously input calculation formula at the virtual card trading web page. After making a lease contract between a lessee and a lessor and before the lessee pays a down payment to the lessor, the seller may repeatedly discount a selling price from the sales information using the virtual card in a virtual card trading system, and the lessee may search again the virtual card, and thus the lessee may have a bargaining power in a lease transaction until the lessee pays the down payment to the lessor.

To this end, through a system for using and trading an Internet-based virtual card which provides a fair and balanced information effect in an unreasonable information asymmetry situation, a receiving and transmitting security certification module using wired or wireless communication is provided to automatically and continuously create the virtual card based on continuously changing sales object information and lease object information and repetitively make a purchase reservation on the virtual card without a monetary expense of a lessee such as an agency cost or the like, and the receiving and transmitting security certification module using wired or wireless communication is provided for agreement on providing personal credit information for credit assessment of the lessee before making a lease contract.

Here, the down payment is an advanced payment of part of a lease contract amount as a security deposit, a prepayment (a prepaid amount), an incidental expense and the like, which is paid by the lessee to the lessor before taking over the leasehold object, and it is directly affected by the credit status of the lessee.

Since a lessee may have increased chances of aggressively and actively comparing and analyzing information on leasehold properties to be used by searching for or re-searching for various kinds of virtual cards in the virtual card trading web page through the trading system, the information asymmetry may be minimized.

Meanwhile, since a lease contract is like lending an object to a lessee on credit from the viewpoint of a lessor, it is essential to make a credit assessment on the lessee, and if the credit assessment can be accomplished through an encrypted security certification performed using a terminal of the lessee through a wired or wireless communication and a module, rather than a face-to-face contact basis credit assessment, the lessor may considerably save time and cost without paying an agency cost.

The virtual card has two types of prices. One is a discounted purchase (sales) price paid by the lessee, and the other is a face amount of the virtual card received by the lessee. For example, if a seller inputs and stores an object in the virtual card trading system as sales information by discounting 10% from the consumer price of 10,000,000 Korean Won (KW), the lessor calculates a lease fee (monthly rental fee) considering his or her internal rate of return, a lease period, a down payment and an additional purchase price based on an original cost of 9,000,000 KW and stores the lease information. At this point, the face amount of the virtual card is determined as 90,000 KW, i.e., 1% of 9,000,000 KW, using a previously input calculation formula, and the trade amount of the virtual card is 9,000 KW obtained by dividing the face amount of 90,000 KW by a discount rate of 10% which is multiplied by 100 beforehand. Since the seller may continue to input (progress) discount of the selling price in the sales information until a lease contract is made between the lessor and the lessee in such a process of calculating a price, the lessee may re-search various types of leasehold properties in a virtual space without any monetary burden in the process of selecting a leaseholder object and receiving a credit assessment by the lessor, and thus the lessee makes a lease contract with the lessor under the condition of a finally reserved virtual card, and a discounted purchase price of the virtual card paid by the lessee and a face amount of the virtual card further larger than the purchase price of the lessee are determined.

Since the amount received by purchasing a virtual card is larger than the amount paid for purchasing the virtual card without paying a special fee by the lessee, reluctance of the lessee to make a purchase reservation on the virtual card is greatly diminished, and since the purchase price of the virtual card can be lowered furthermore while a deal is progressed or a virtual card of a different condition may be purchased owing to the present invention, a lessee may aggressively and actively repeat comparison and analysis of information on leasehold properties to be used and selection of a leasehold object using various types of virtual cards in the virtual card trading system.

From the viewpoint of a seller or a lessor looking and searching for a customer, if a customer is secured in advance and sale of properties is promoted through a virtual card purchase reservation, the seller or the lessor may have a room for reducing the selling price or the lease price furthermore. The reason of obtaining such a result is that a selling price or a lease price should be calculated by adding a business expense since a ratio of marketing target customers reaching to a lease contract is low although expenses for public relations, commissions, and expenses for sales promotion are paid for a large number of marketing target customers, but the selling price or the lease price may be lowered while minimizing the business expense for the previously secured customer who makes a purchase reservation on the virtual card as shown in the present invention, or part of the business expense may be directly used as an incidental sales charge for the customer (lessee).

In addition, since a lease contract is like lending an object by a lessor to a lessee on credit, it is essential to make a credit assessment on the lessee (the character, ability, financial status, security solvency, credit insurance or the like of the customer). If the credit assessment can be accomplished by authentication performed using a terminal of the lessee through a wired or wireless communication and a module, rather than a face-to-face contact basis credit assessment, the lessor may considerably save cost and reduce work flow.

The spirit of the present invention described above is implemented by a system including the constitutional components described below. That is, a virtual card trading system connectible through a network in a lease contract according to a first characteristic of the present invention includes: a means for registering and storing information on a seller, a lessor and a lessee through a seller terminal, a lessor terminal and a lessee terminal; a means for inputting and storing sales object information through the seller terminal; a means for calculating a lease condition and a lease price through the lessor terminal using the sales object information input through the seller terminal as a base data, and storing lease object information including information on the lease condition and the lease price of the lease object; a means for storing the lease object information calculated through the lessor terminal as virtual card information, and automatically creating a virtual card; a means for making a purchase reservation and a deal by the lessee using the virtual card information through the lessee terminal and determining a virtual card price by discounting the virtual card price to be paid to the lessor by the lessee if a lease contract is made; and a means for determining a face amount of the virtual card to be paid to the lessee by the lessor and storing information on the face amount.

In this specification, the seller, the lessor and the lessee used in the system and method of the present invention are used in terms of a seller terminal or an equivalent, a lessor terminal or an equivalent, and a lessee terminal or an equivalent, in addition to a meaning of a person who sells an object, a person who leases out an object and a person who holds a lease.

The system described above may further include a virtual card trade market site for trading the virtual card, and a payment information system configured of a process for paying the determined face amount of the virtual card to the lessee by the lessor if the lessee pays the virtual card purchase price determined by discounting the virtual card price and a down payment to the lessor.

In addition, the virtual card may include following items such as a virtual card number item showing a virtual card number selected among a plurality of randomly created numbers, a virtual card face amount item showing a face amount of a virtual card determined at a predetermined ratio of a purchase price of a lessor or a discounted price of a seller, a virtual card selling price item showing a virtual card selling price transferred to the lessee by the lessor and calculated as a value obtained by dividing the face amount of the virtual card by a discount rate, a virtual card lease object item showing a title of the sales object information, a consumer price item showing a consumer price included in the sales object information, a lease period item showing a lease period included in the lease object information, a down payment item showing a down payment included in the lease object information, a lease price item showing a lease price included in the lease object information, and an additional purchase price item showing an additional purchase price included in the lease object information.

In addition, an item showing a picture (a single picture or pictures taken from the top, down, left and right sides) of a sales object or a lease object and a valid period item may be further included in the virtual card.

Meanwhile, the spirit of the present invention described above is implemented by a method including the constitutional components described below. That is, a virtual card trading method in a lease contract according to a second characteristic of the present invention includes: (A) a procedure of calculating a lease condition and a lease price at the lessor terminal based on the sales object information input through the seller terminal, and storing information on the lease condition and the lease price of the lease object; (B) a procedure of automatically creating a virtual card based on the lease object information calculated at the lessor terminal and storing information on the virtual card; and (C) a procedure of making a purchase reservation and a deal using the virtual card information at the lessee terminal, determining a virtual card price by discounting the virtual card price to be paid to a lessor by a lessee if a lease contract is made, determining a face amount of the virtual card to be paid to the lessee by the lessor, and storing information on the discounted price and the face amount.

Here, the steps (A), (B), and (C) are not arranged in the sequence of time. That is, they are not time-dependent constitutional components. To express the steps, they are expressed as “a procedure of”, instead of “a step of” which is a conventional time-dependent expression method. Since a transaction performing the method expressed as ‘procedures’ is not arranged in the sequence of time, both a case of arbitrarily changing the sequence of the procedures and a case of almost simultaneously performing the procedures are within the scope of the method according to the present invention. However, a transaction meaningful in the sequence of time is expressed as the conventional expression of ‘steps’.

In the procedure (A), a title of a sales object, a consumer price of the sales object, a discounted price of the sales object and a discount rate of the sales object may be input as sales object information, and, in addition, a discount period of the sales object may be additionally input.

In the procedure (B), if the lessor terminal is connected to the virtual card trading system and information on the lessor is transmitted, it is possible to automatically create a virtual card based on the lease object information, calculate a down payment, a lease period, an additional purchase price and a lease fee for a lease object using the sales object information, and store the lease object information.

The procedure (C) includes, a procedure of reading, if information on the lessee is transmitted from the lessee terminal connected to the virtual card trading system, a plurality of virtual cards from a virtual card information storage means, outputting the virtual cards through the lessee terminal, selecting one of the virtual cards by the lessee among the plurality of virtual cards, and making a purchase reservation on the selected virtual card; a procedure of confirming whether or not to determine a virtual card price by the lessee if the purchase reservation is made; a procedure of providing information on the virtual card to the lessee terminal to determine a face amount of the virtual card if a virtual card price is determined through the lessee terminal, and branching to a virtual card reselection determination step if the virtual card price is not determined through the lessee terminal; and a procedure of confirming whether or not the lessee has paid the price of the virtual card, on which the purchase reservation is made, to the lessor if the virtual card price is determined and a lease contract is made between the lessee and lessor, canceling the purchase reservation of the virtual card and terminating the procedure if the virtual card price is not paid, and processing to pay the face amount of the virtual card to the lessee by the lessor and terminating the procedure if the virtual card price and the down payment are paid to the lessor terminal.

Meanwhile, the reselection determination step is a step of determining whether or not the lessee terminal reselects a virtual card. Here, if the lessee terminal does not reselect a virtual card, the purchase reservation of the virtual card is cancelled, and the procedure is terminated, and if the lessee terminal reselects a virtual card, the lessee terminal selects another virtual card, and the purchase reservation on the virtual card is processed again.

In addition, a step of confirming whether or not the lessee has paid the down payment to the lessor, and determining, if the lessee has not paid the down payment to the lessor, whether or not the lessee will reselect a virtual card through the lessee terminal may be further included.

In addition, a step of assessing credit of the lessee may be further included.

Meanwhile, according to a third characteristic of the present invention, there is provided a virtual card configured of the following items. Since each of the items of this virtual card is the same as described above, it will not be described separately.

The spirit of the present invention as described above may be implemented to be stored in a computer-readable recording medium. In addition, since the procedures (A) to (D) in the method of the present invention do not mean steps which are dependent on the sequence of time, it is apparent to those skilled in the art that the sequence of execution may be modified.

### BRIEF DESCRIPTION OF THE DRAWINGS

FIG. 1 is a view showing the configuration of a virtual card trading system for implementing an embodiment of the present invention.

FIG. 2 is an exemplary view showing a virtual card used in an embodiment of the invention.

FIG. 3 is a flowchart illustrating a procedure of inputting and storing seller information and sales object information by a seller in a virtual card trading system of an embodiment according to the present invention.

FIG. 4 is a flowchart specifically illustrating a procedure of inputting seller information by a seller in FIG. 3.

FIG. 5 is a flowchart specifically illustrating a procedure of inputting sales object information by a seller in FIG. 3.

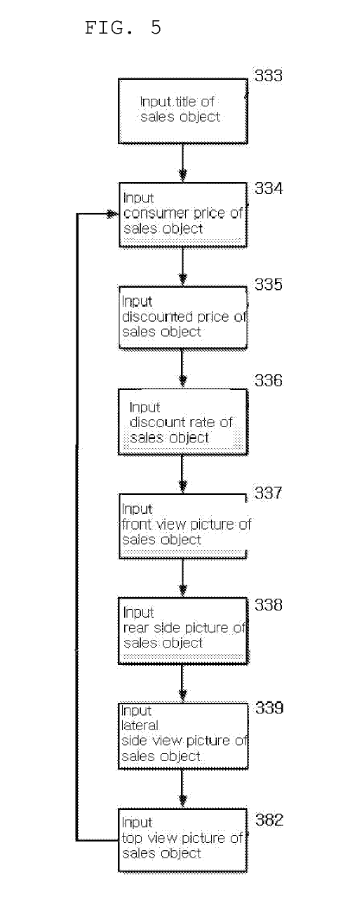

FIG. 6 is a flowchart illustrating a procedure of automatically creating and storing a virtual card from lessor information and lease object information by a lessor in a virtual card trading system according to an embodiment of the present invention.

FIG. 7 is a flowchart illustrating a procedure of inputting lessor information by a lessor in FIG. 6.

FIG. 8 is a flowchart illustrating a procedure of calculating a down payment, a lease period, an additional purchase price and a monthly lease fee for a lease object from sales object information and storing lease object information in order to use as virtual card information by a lessor in FIG. 6.

FIG. 9 is a flowchart illustrating a procedure of selecting a virtual card, making a purchase reservation, receiving a credit assessment, making a lease contract, paying for the virtual card on which a purchase reservation is made, and receiving a face amount of the virtual card by a lessee.

FIG. 10 is a flowchart illustrating a procedure of inputting lessee information by a lessee in FIG. 9.

FIG. 11 is a flowchart illustrating a procedure of determining s face amount and a purchase price of a virtual card by a lessee in FIG. 9.

FIG. 12 is a flowchart illustrating a procedure of certifying a purchase reservation of the virtual card by a lessee in FIG. 9.

FIG. 13 is a flowchart illustrating a procedure of certifying agreement on providing credit assessment information by a lessee in FIG. 9.

### DETAILED DESCRIPTION OF THE PREFERRED EMBODIMENT

Hereinafter, the present invention will be described through a representative embodiment among a large number of embodiments for implementing the spirit of the present invention.

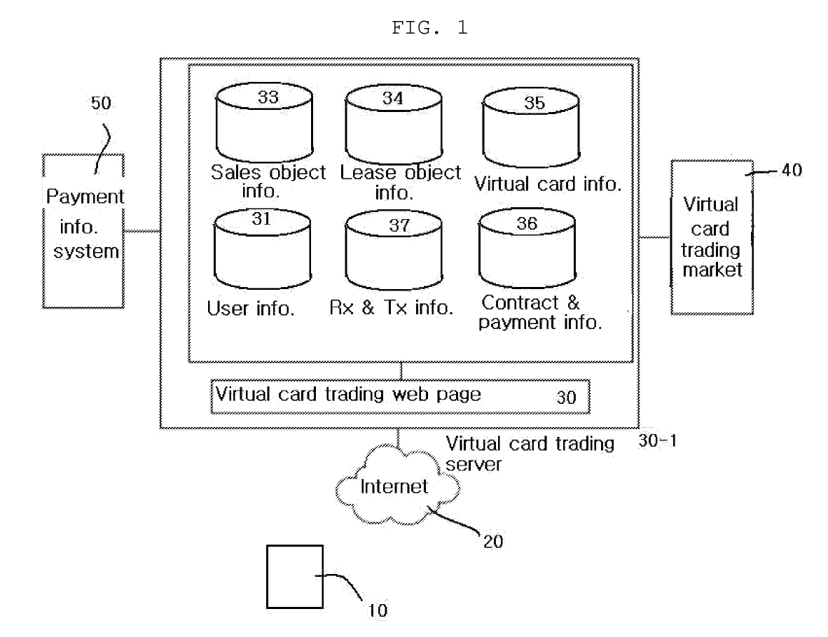

Referring to FIG. 1, in an embodiment of a system according to the present invention, a virtual card trading server 30-1 provided with a web page 30 of a virtual card trading web site and various databases through the Internet 20 includes a user information DB server 31 for registering information on a seller, a lessor and a lessee by themselves, a sales object information DB server 33 for inputting and storing sales object information by the seller, a lease object information DB server 34 for storing a solution for calculating a lease condition and a lease price by the lessor using the sales object information input by the seller and information on the lease condition and the lease price for the lease object, a virtual card information DB server 35 for storing a solution for automatically creating the virtual card from the lease object information calculated by the lessor and virtual card information, a contract and payment information DB server 36 for storing a solution for searching for and selecting virtual card information and making a purchase reservation and trading a virtual card by the lessee, a solution for storing or canceling the purchase reservation, making a lease contract between the lessee and the lessor, determining a price of the virtual card by discounting the virtual card price to be paid to the lessor by the lessee, and determining a face amount of the virtual card to be paid to the lessee by the lessor, and information thereon, and a receiving and transmitting information DB server 37 for wiredly or wirelessly encrypting and certifying the purchase reservation made by the lessee, and wiredly or wirelessly encrypting and certifying agreement on providing credit assessment information of the lessee, by the lessee himself or herself. In addition, the virtual card trading system further includes a virtual card trade market site 40 for trading the virtual card according to the present invention, a payment information system 50 configured to pay a determined face amount of the virtual card to a lessee by a lessor if the lessee pays a virtual card purchase price determined by discounting the price to the lessor and the lessee pays a down payment to the lessor, and a terminal 10 for inputting information by the seller, the lessor and the lessee, certifying security of the information and outputting the information.

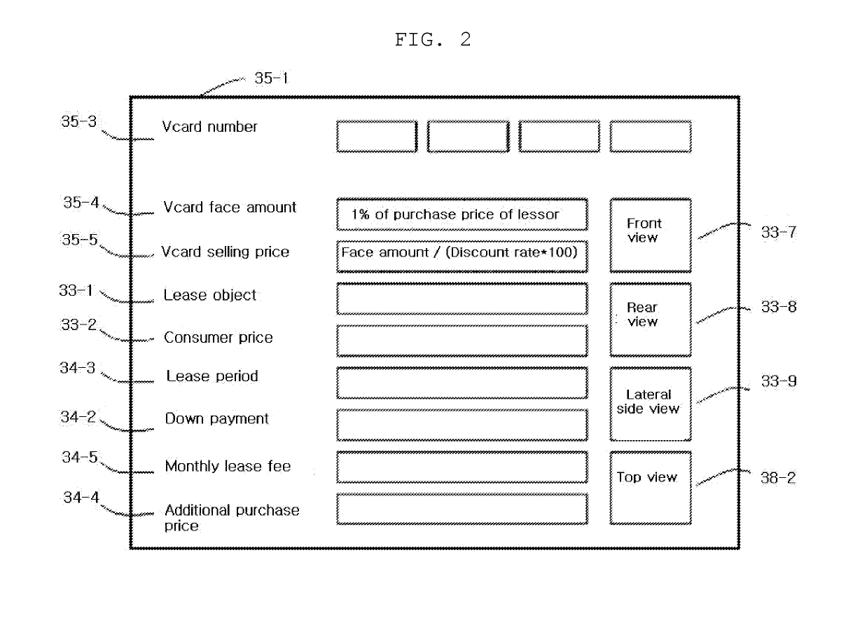

The virtual card which is a trading target in a lease contract according to the present invention is introduced in FIG. 2, and this virtual card will be described when an embodiment of a method according to the present is described.

An embodiment of a method according to the present invention accomplished in a system configured as shown in FIG. 1 is described using a flowchart.

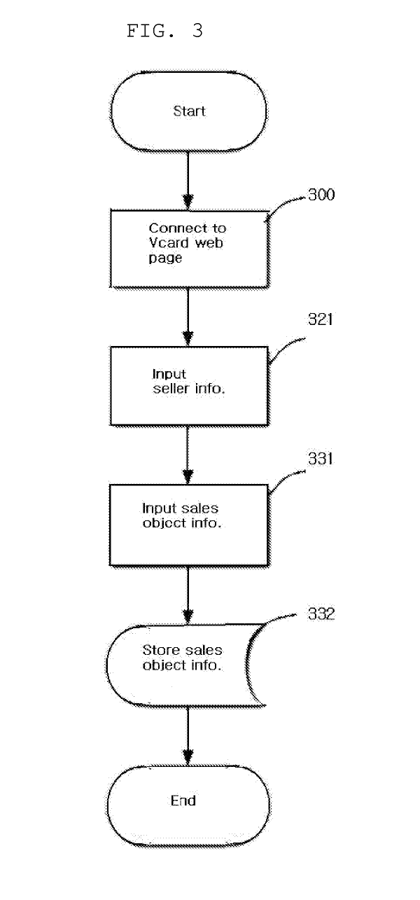

Referring to FIG. 3, in order to register the seller information and seals object information, a seller connects 300 to a virtual card web page, inputs 321 the seller information, inputs 331 the sales object information and then stores 332 the sales object information.

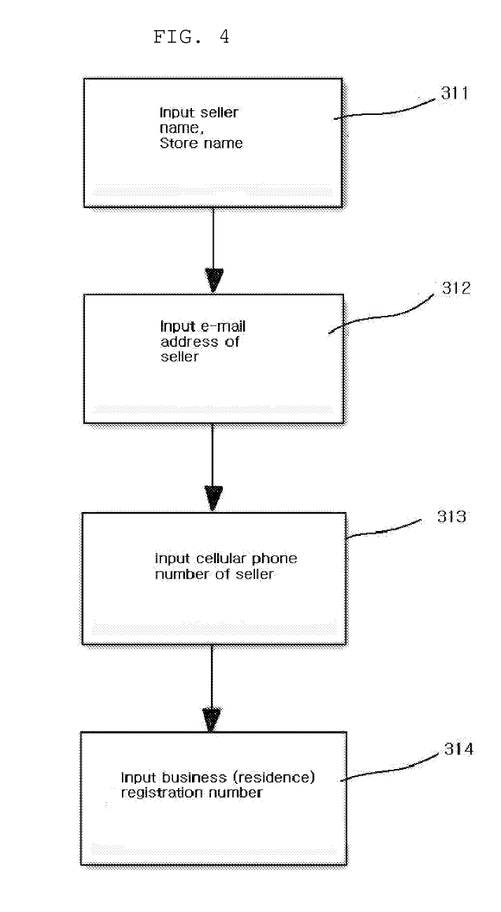

Here, although it is designed to include a seller name or a store name 311, an e-mail address of the seller 312, a cellular phone of the seller 313, and a business registration number or a residence registration number of the seller 314 as detailed information of the input 321 of the seller information as shown in FIG. 4, it is apparent to those skilled in the art that details of the seller information are not limited thereto in another embodiment.

The procedure 331 of inputting the sales object information of the seller in FIG. 3 may include inputting a title of a sales object 333, inputting a consumer price of the sales object 334, inputting a discounted price of the sales object 335, inputting a discounted rate of the sales object 336, inputting a picture of the front view of the sales object 337, inputting a picture of the rear side of the sales object 338, inputting a picture of the lateral side view of the sales object 339, and inputting a picture of the top view of the sales object 382. In another embodiment, a discount period can be added to these input items as an option. If the products or goods are out of stock or the discount period is elapsed, the virtual card will not be valid.

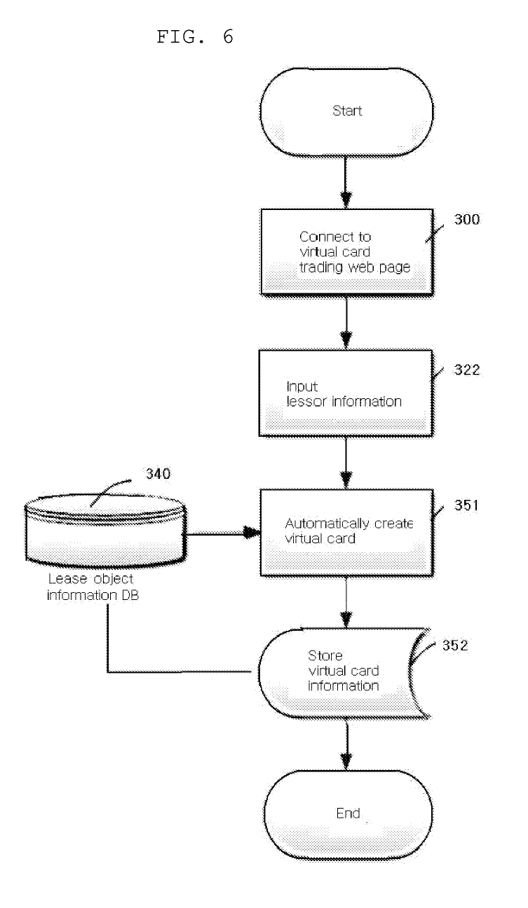

Meanwhile, describing the procedure of automatically creating and storing a virtual card by the lessor based on lessor information and lease object information with reference to FIG. 6, if a lessor connects 300 to the virtual card trading web page and inputs 322 the lessor information, the lease object information is read from the lease object information DB 34, and a virtual card is automatically created 351. Then, if the lessor performs a procedure of calculating a down payment, a lease period, an additional purchase price and a monthly lease fee for a lease object from the sales object information and storing the lease object information to use them as virtual card information, the information on the virtual card is stored 352.

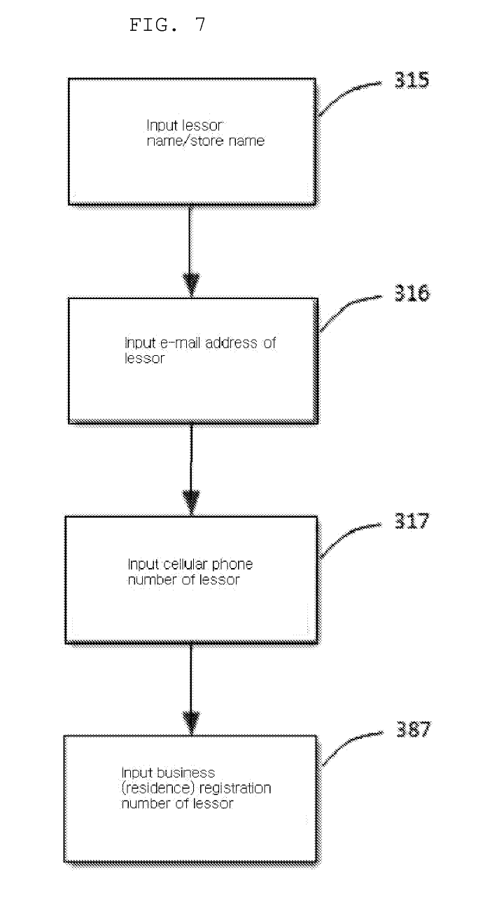

As shown in FIG. 7, the procedure of inputting the lessor information 322 includes the procedures of inputting a lessor name or a store name 315, inputting an e-mail address of the lessor 316, inputting a cellular phone of the lessor 317, and inputting a business registration number or a residence registration number of the lessor 387.

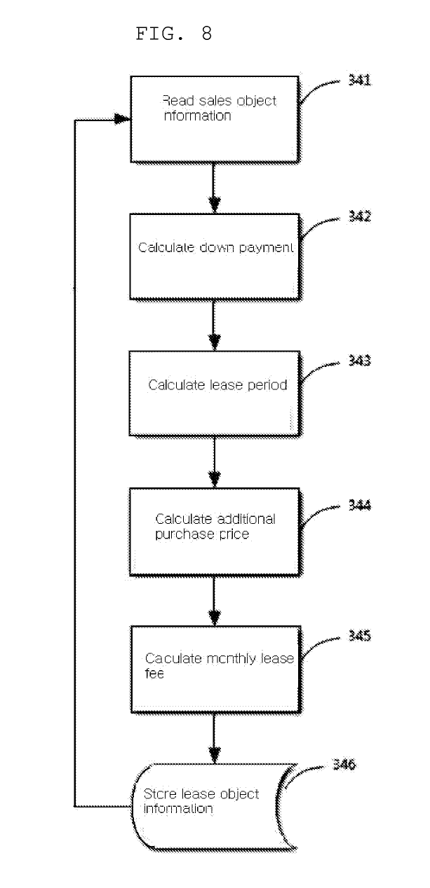

Referring to FIG. 8, in the procedure of storing 352 the virtual card information including the lease object information stored by the lessor, if the sales object information is read from the sales object information DB 33, the down payment is calculated 342, the lease period is calculated 343, the additional purchase price is calculated 344, the monthly lease fee (monthly rental fee) is calculated 345, and the calculated values are stored 346 in the lease object information DB 34.

Now, at this point, the virtual card is described returning to FIG. 2. A number randomly selected but not to be duplicated among one hundred thousands randomly created 12-digit numbers is created as a virtual card number 35-4 of a virtual card 35-1. A face amount 35-4 of the virtual card is determined to be 1% of a purchase price of the lessor, and the purchase price of the lessor is the same as a discounted price 33-5 of the seller, i.e., “(Consumer price)×(1-Discount rate)”. That is, the discounted price 33-5 input by the seller is stored 332 in the sales object information DB 33, and if the lessor reads the discounted price from the lease object information DB 34, 1% of the purchase price of the lessor is automatically created as the face amount in the virtual card 35-1. A selling price 35-5 of the virtual card is an amount transferred to the lessee by the lessor and is calculated as {Face amount of virtual card÷(Discount rate×100)}. Accordingly, if the discount rate is increased, the virtual card selling price 35-5 will be decreased, and thus the virtual card 35-1 can be purchased at a lower price from the viewpoint of the lessee if a higher discount rate is applied to the consumer price of the seller. A leasehold object 33-1 of the virtual card is a lease object of lease information, and a title of a sales object is created as is as the sales object of the sales information. The consumer price 33-2 is created as is from the sales object information DB 33 as the consumer price 33-2, the lease period 34-3 is created as is from the lease object information DB 34 as the lease period 34-3, the down payment 34-2 is created as is from the lease object information DB 34 as the down payment 34-2, the monthly rental fee 34-5 is created as is from the lease object information DB 34 as the monthly rental fee 34-5, and the additional purchase price 34-4 is created as is from the lease object information DB as the additional purchase price 34-4. The front view picture 33-7 is created as is from the sales object information DB 33 as the front view picture 33-7, the rear side picture 33-8 is created as is from the sales object information DB 33 as the rear side picture 33-8, the lateral side view picture 33-9 is created as is from the sales object information DB 33 as the lateral side view picture 33-9, and the top view picture 38-2 is created as is from the sales object information DB 33 as the top view picture 38-2. Meanwhile, in another embodiment, a virtual card valid period may be added in the virtual card as an option. If this valid period is elapsed, the virtual card will be invalidated.

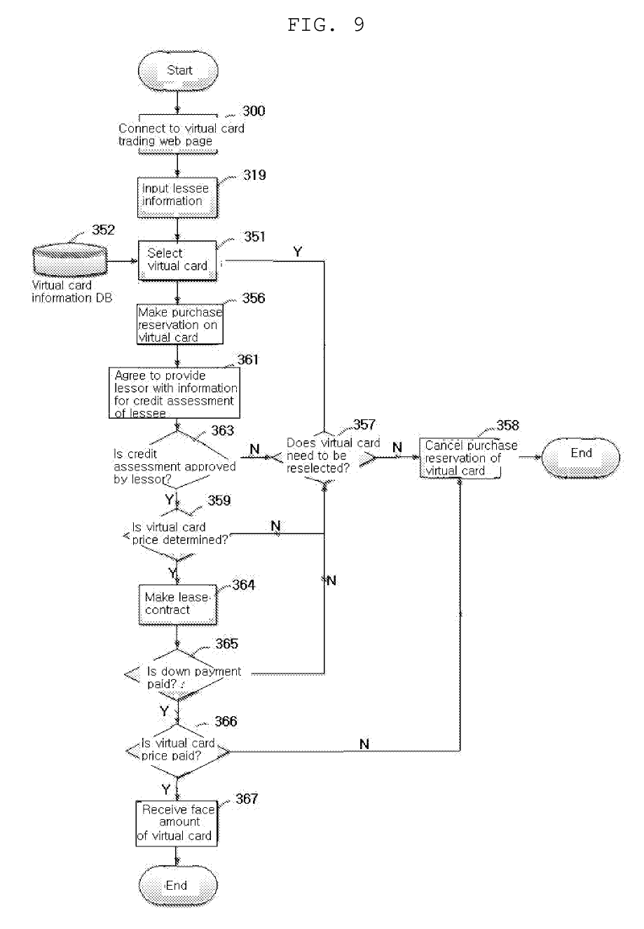

FIG. 9 is a flowchart illustrating a procedure of selecting the created virtual card 35-1, making a purchase reservation, receiving a credit assessment, making a lease contract, paying for the virtual card on which a purchase reservation is made, and receiving a face amount of the virtual card by a lessee.

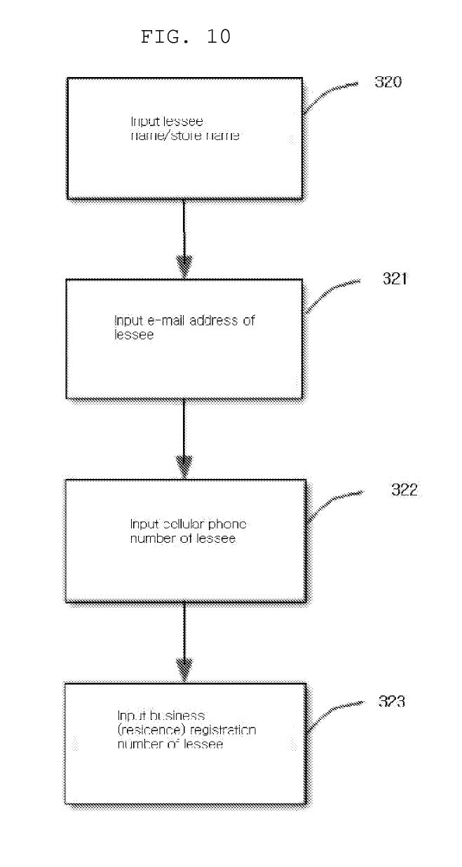

The lessee connects 300 to a virtual card trading web page and inputs 319 lessee information. As shown in FIG. 10, detailed content of the input includes a lessee name or a store name 320, an e-mail address of the lessee 321, a cellular phone number of the lessee 322, and a business registration number or residence registration number of the lessee 323.

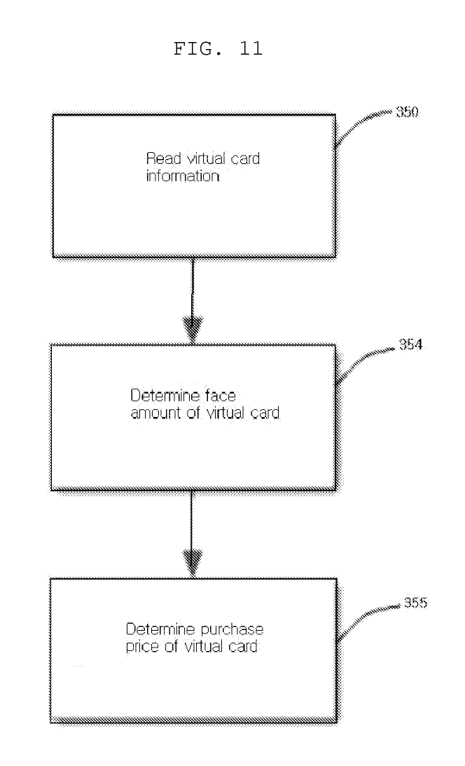

Next, as shown in FIG. 9, the lessee selects 351 one of virtual cards read from the virtual card information DB 35, makes a purchase preservation 356 on the selected virtual card 35-1, agrees 361 on providing the lessor with information for credit assessment of the lessee himself or herself, confirms 363 whether or not the lessor approves the credit assessment of the lessee, and, if the credit assessment of the lessee is not approved in the credit assessment, determines 357 whether or not the lessee will reselect a virtual card 35-1. If the lessee does not reselect a virtual card 35-1, the purchase reservation of the virtual card 35-1 is cancelled 358, and the process is terminated, and if the lessee reselects a virtual card 35-1, the lessee selects 351 another virtual card 35-1, makes a purchase reservation again on the virtual card 35-1, agrees 361 on providing the lessor with information for credit assessment of the lessee himself or herself, and confirms again 363 whether or not the lessor approves the credit assessment of the lessee. If the credit assessment is approved, it is determined 359 whether or not to determine a virtual card price. If a virtual card price is to be determined, as shown in FIG. 11, the lessee reads 350 the virtual card information DB 35 and determines 354 a face amount 35-4 of the virtual card, and a virtual card price 355 of the virtual card reserved to purchase by the lessee is determined.

Returning to FIG. 9 again, if the lessee does not determine the virtual card price 355 at the determination procedure 359, the flow branches to a reselection determination procedure 357 of reselecting a virtual card 35-1 by the lessee. If the lessee determines the virtual card price 355, the lessee makes a lease contract 364 with the lessor. Then, it is confirmed 365 whether or not the lessee has paid the down payment 34-2 to the lessor, and if the lessee has not paid the down payment 34-2 to the lessor, it is determined 357 whether or not a virtual card 35-1 will be reselected by the lessee, and if the lessee has paid the down payment 34-2 to the lessor, it is confirmed 366 whether or not the lessee has paid the virtual card price 35-5 of a virtual card reserved to purchase to the lessor. If the virtual card price 35-5 is not paid, the purchase reservation of the virtual card 35-1 is cancelled 358, and the procedure is terminated. If the lessee has paid both the virtual card price 35-5 of a virtual card reserved to purchase and the down payment 34-2 to the lessor, the lessee receives 367 the face amount 35-4 of the virtual card 35-1 from the lessor.

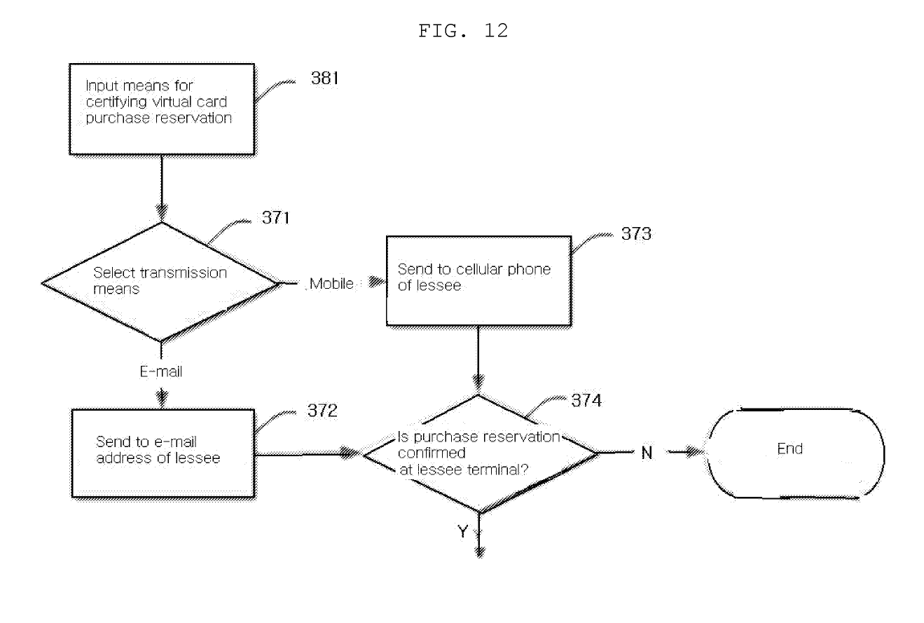

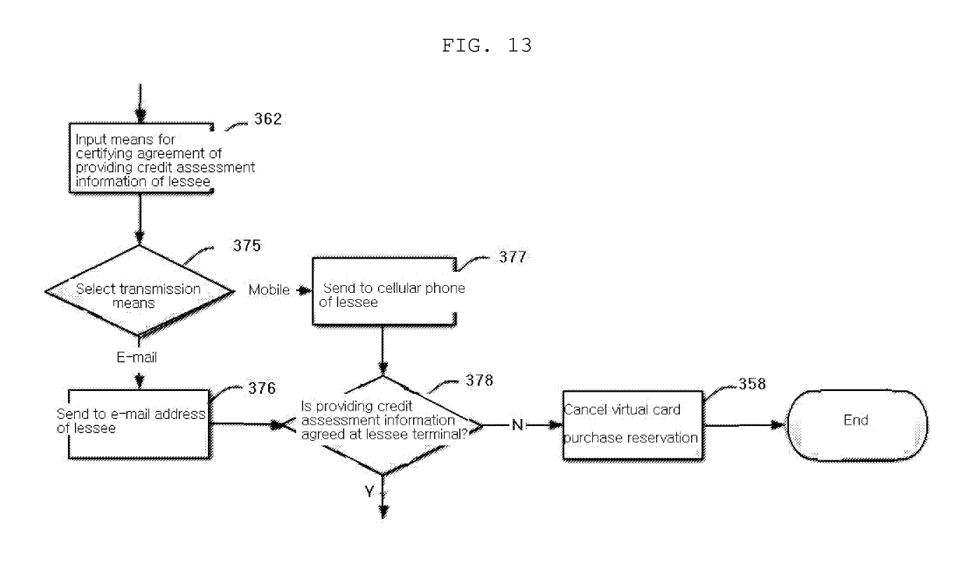

Referring to FIG. 12, if the lessee inputs 381 a certification means to make a purchase reservation (356 of FIG. 9) on the virtual card, selects 371 a transmission means, and sends the purchase reservation to an e-mail address 372 or the cellular phone 373 of the lessee, the lessee confirms 374 and certifies the received purchase reservation. If the lessee does not confirm and certify the purchase reservation, the procedure is terminated, and if the lessee certifies the purchase reservation, the flow goes to FIG. 13, and if the lessee inputs 362 a means for certifying agreement (361 of FIG. 9) on providing the lessor with information for credit assessment of the lessee, selects 375 a transmission means, and sends the agreement to an e-mail address 376 or the cellular phone 377 of the lessee in order to make a lease contract, the lessee confirms 378 and certifies the received information providing agreement. If the lessee certifies the agreement, the flow goes to the procedure of confirming approval of the lessor on the credit assessment of the lessee (363 of FIG. 9), and if the lessee fails in certifying the information providing agreement, the purchase reservation of the virtual card is cancelled, and the procedure is terminated.

According to the present invention, since the conventional information asymmetry problem is fundamentally solved, rapid and correct information efficiency can be secured using an Internet-based virtual card as a means for signal effect and information effect, and thus new information is rapidly and correctly reflected in a lease market without an overreaction and a delayed reaction to the lease market, and, therefore, the information efficiency is improved, and a fair and balanced price structure and trading structure can be accomplished by sharing information on sales properties and lease properties among users. In addition, since the trading structure is simplified and the manufacturing cost is saved by adopting a trade certification system using a wired or wireless communication technique, a selling price may be lowered by the effect of reducing incidental expenses of the seller, and a lease price may be lowered by reducing an acquisition cost and the incidental expenses of the lessor, and the lessee may lower abnormal trades by paying a lower lease price without wasting time and cost to search for a lease object and make a contract.

Describing additionally, it may be possible in the present invention to avoid an unreasonable trading structure in which a customer (lessee) makes a contract with a lessor at a different price depending on a difference personal situation of the lessee although a seller having plenty of sales information sells the same object in a limited space of a showroom targeting limited customers (lessees), and if the seller saves business expenses such as expenses for public relations, distribution cost and the like, the seller inputs and stores the sale information in a virtual card trading web page at a price discounted as much as the saved cost, and the lessor reads the stored discounted sales information and processes and stores as lease information, and then a virtual card including the lease information is automatically created by a calculation formula previously stored in the virtual card trading system based on the stored lease information. Therefore, the present invention is effective in that since the sales information is open in the virtual card trading system, information symmetry can be secured, and a fair market price can be formed.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A virtual card trading system for making a lease contract, the system connectible through a network, comprising:
a unit for registering and storing information on a seller, a lessor and a lessee if the information is input through a seller terminal, a lessor terminal and a lessee terminal;
a unit for storing sales object information input through the seller terminal;
a unit for calculating information on a lease condition and a lease price through the lessor terminal using the sales object information as a base data, and storing the information on the lease condition and the lease price;
a unit for storing the lease object information calculated through the lessor terminal as virtual card information, and automatically creating a virtual card;
a unit for making a purchase reservation and a deal by the lessee using the virtual card information through the lessee terminal and determining a virtual card price by discounting the virtual card price to be paid to the lessor by the lessee if a lease contract is made; and
a unit for determining a face amount of the virtual card which will be sent from the lessor terminal to the lessee terminal and storing information on the face amount.

2. The system according to claim 1, further including:
a virtual card trade market site for trading the virtual card; and
a payment information system configured of a process for paying the determined face amount of the virtual card to the lessee by the lessor if the lessee pays a virtual card purchase price determined by discounting the virtual card price and a down payment to the lessor.

3. The system according to claim 1, wherein the virtual card includes:
a virtual card number item showing a virtual card number selected among a plurality of randomly created numbers,
a virtual card face amount item showing a face amount of a virtual card determined at a predetermined ratio of a purchase price of a lessor or a discounted price of a seller,
a virtual card selling price item showing a virtual card selling price transferred to the lessee by the lessor and calculated as a value obtained by dividing the face amount of the virtual card by a discount rate,
a virtual card lease object item showing a title of the sales object information,
a consumer price item showing a consumer price included in the sales object information,
a lease period item showing a lease period included in the lease object information,
a down payment item showing a down payment included in the lease object information,
a lease price item showing a lease price included in the lease object information, and
an additional purchase price item showing an additional purchase price included in the lease object information.

4. The system according to claim 3, wherein the virtual card further includes an item showing a picture of a sales object or a lease object.

5. The system according to claim 1, wherein the virtual card further includes a valid period item.

6. A method of trading a virtual card in a virtual card trading system for making a lease contract of claim 1, the method comprising:
(A) a procedure of calculating a lease condition and a lease price at the lessor terminal based on the sales object information input through the seller terminal, and storing information on the lease condition and the lease price of the lease object;
(B) a procedure of automatically creating a virtual card based on the lease object information calculated at the lessor terminal and storing information on the virtual card; and
(C) a procedure of determining, if a purchase reservation and a deal are made using the information on the virtual card and a lease contract is made, a discounted price of the virtual card price to be paid to a lessor by a lessee and a face amount of the virtual card to be paid to the lessee by the lessor, and storing information on the discounted price and the face amount at the lessor terminal.

7. The method according to claim 6, wherein the sales object information input through the seller terminal in the procedure (A) includes a title of the sales object, a consumer price of the sales object, a discounted price of the sales object, and a discount rate of the sales object.

8. The method according to claim 7, wherein the sales object information input through the seller terminal in the procedure (A) further includes a discount period of the sales object.

9. The method according to claim 6, wherein the procedure (B) includes the steps of automatically creating a virtual card based on the lease object information if the lessor terminal is connected to the virtual card trading system and information on the lessor is transmitted, calculating a down payment, a lease period, an additional purchase price and a lease price for a lease object using the sales object information, and storing the lease object information.

10. The method according to claim 6, wherein the step (C) includes:
(C-1) a procedure of reading, if information on the lessee is transmitted from the lessee terminal connected to the virtual card trading system, a plurality of virtual cards from a virtual card information storage unit, and outputting one of the virtual cards selected among the plurality of virtual cards through the lessee terminal so that the lessee may make a purchase reservation on the selected virtual card;
(C-2) a procedure of providing information on the virtual card to the lessee terminal to determine a face amount of the virtual card by the lessee if whether or not to determine the virtual card price is confirmed by the lessee who has made the purchase reservation and a virtual card price is determined through the lessee terminal, and branching to a virtual card reselection determination step if the virtual card price is not determined by the lessee through the lessee terminal; and
(C-3) a procedure of confirming whether or not the lessee has paid the price of the virtual card, on which the purchase reservation is made through the lessee terminal, to the lessor if the virtual card price is determined and a lease contract is made between the lessee and lessor, canceling the purchase reservation of the virtual card and terminating the procedure if it is determined that the virtual card price is not paid, and processing to pay the face amount of the virtual card to the lessee by the lessor and terminating the procedure if it is determined that the virtual card price is paid to the lessor terminal.

11. The method according to claim 10, wherein the reselection determination step is a step of determining whether or not the lessee terminal reselects a virtual card, wherein if it is determined that the lessee terminal does not reselect a virtual card, the purchase reservation of the virtual card is cancelled, and the procedure is terminated, and if it is determined that the lessee terminal reselects a virtual card, the lessee terminal selects another virtual card, and the purchase reservation on the virtual card is processed again.

12. The method according to claim 10, wherein the step (C-3) further includes the step of confirming whether or not the lessee has paid the down payment to the lessor, and requesting, if it is determined that the lessee has not paid the down payment to the lessor, to determine whether or not the lessee will reselect a virtual card through the lessee terminal.

13. The method according to claim 10, wherein any one of steps (C-1) to (C-3) further includes a step of assessing credit of the lessee.

14. The method according to claim 6, wherein the virtual card includes:
a virtual card number item showing a virtual card number selected among a plurality of randomly created numbers,
a virtual card face amount item showing a face amount of a virtual card determined at a predetermined ratio of a purchase price of a lessor or a discounted price of a seller,
a virtual card selling price item showing a virtual card selling price transferred to the lessee by the lessor and calculated as a value obtained by dividing the face amount of the virtual card by a discount rate,
a virtual card lease object item showing a title of the sales object information,
a consumer price item showing a consumer price included in the sales object information,
a lease period item showing a lease period included in the lease object information,
a down payment item showing a down payment included in the lease object information,
a lease price item showing a lease price included in the lease object information, and
an additional purchase price item showing an additional purchase price included in the lease object information.

15. The virtual card according to claim 14, wherein the virtual card further includes an item showing a picture of a sales object or a lease object.

16. The virtual card according to claim 14, wherein the virtual card further includes a valid period item.

17. A computer-readable recording medium in which a method according to claim 6 is implemented.
